(19) United States
(12) Patent Application Publication
(10) Pub. No.: US 2014/0263209 A1
(43) Pub. Date: Sep. 18, 2014

(54) APPARATUS AND METHODS FOR MANUFACTURING

(71) Applicant: Matterfab Corp., Bloomington, IN (US)

(72) Inventors: Matthew Burris, Bloomington, IN (US); Andrew Dolgner, Bloomington, IN (US)

(73) Assignee: Matterfab Corp., Bloomington, IN (US)

(21) Appl. No.: 14/213,352

(22) Filed: Mar. 14, 2014

Related U.S. Application Data
(60) Provisional application No. 61/787,659, filed on Mar. 15, 2013.

(51) Int. Cl. C23C 24/08; B23K 26/08; B23K 26/03; B23K 26/34

(52) U.S. Cl. CPC C23C 24/08; B23K 26/34; B23K 26/0807; B23K 26/0815; B23K 26/034
USPC 219/121.62; 219/121.76; 219/121.73; 219/121.75

(57) ABSTRACT

An apparatus for manufacturing includes: a build chamber including a build platform; a material dispenser configured to distribute a layer of powdered material over the build platform; a mirror arranged over the build platform and defining a mirrored planar surface; a first laser output optic configured to output a first energy beam toward the mirror; a second laser output optic adjacent the first laser output optic and configured to output a second energy beam toward the mirror; a first actuator configured to maneuver the first laser output optic and the second laser output optic relative to the build platform; a lens arranged between the mirror and the build platform; and a second actuator configured to maneuver the mirror to scan the first and second energy beams across the lens, the lens outputting the first energy beam and the second energy beam toward and substantially normal to the build platform.

### CROSS-REFERENCE TO RELATED APPLICATIONS

The application claims the benefit of U.S. Provisional Patent Application No. 61/787,659, filed on 15 Mar. 2013, which is incorporated in its entirety by this reference.

### TECHNICAL FIELD

This invention relates generally to laser sintering machines and more specifically to a new and useful apparatus and methods for manufacturing in the field of laser sintering machines.

### BRIEF DESCRIPTION OF THE FIGURES

FIG. 1 is schematic representations of an apparatus of the invention;

FIG. 2 is a schematic representation of one variation of the apparatus;

FIGS. 3A and 3B are schematic representations of variations of the apparatus;

FIGS. 4A, 4B, 4C, and 4D are schematic representations of variations of the apparatus;

FIG. 5 is a schematic representation of one variation of the apparatus;

FIG. 6 is a schematic representation of one variation of the apparatus;

FIG. 7 is a flowchart representation of a method of the invention;

FIG. 8 is a flowchart representation of one variation of the method;

FIG. 9 is a flowchart representation of one variation of the method;

FIG. 10 is a schematic representation of one variation of the method;

FIG. 11 is a schematic representation of one variation of the method; and

FIGS. 12A and 12B are schematic representations of variations of the method.

### DESCRIPTION OF THE EMBODIMENTS

The following description of the embodiment of the invention is not intended to limit the invention to these embodiments, but rather to enable any person skilled in the art to make and use this invention.

### 1. Apparatus

As shown in FIG. 1, an apparatus 100 for manufacturing includes: a build chamber 110 including a build platform 112; a material dispenser 120 configured to distribute a layer of powdered material over the build platform 112; a mirror 130 arranged over the build platform 112, defining a mirrored planar surface, and isolated from an environment within the build platform 112; a first laser output optic 141 configured to output a first energy beam toward the mirror; a second laser output optic 142 adjacent the first laser output optic 141 and configured to output a second energy beam toward the mirror; a first actuator 151 configured to maneuver the first laser output optic 141 and the second laser output optic 142 relative to the build platform 112; a lens 160 arranged between the mirror 130 and the build platform 112; and a second actuator 152 configured to maneuver the mirror 130 to scan the first energy beam and the second energy beam across the lens 160, the lens 160 outputting the first energy beam and the second energy beam toward and substantially normal to the build platform 112.

As shown in FIG. 2, one variation of the apparatus 100 for manufacturing includes: a build chamber 110 including a build platform 112; a material dispenser 120 configured to distribute a layer of powdered material over the build platform 112; a first laser output optic 141 configured to output a first energy beam toward the build platform 112 and substantially normal to the layer of powdered material; a second laser output optic 142 adjacent the first laser output optic 141 and configured to output a second energy beam substantially parallel to and offset from the first energy beam; a first actuator 151 configured to maneuver the first laser output optic 141 and the second laser output optic 142 along a first axis parallel to the layer of powdered material; and a second actuator 152 configured to maneuver the first laser output optic 141 and the second laser output optic 142 along a second axis parallel to the layer of powdered material and perpendicular to the first axis.

Generally, the apparatus 100 functions as an additive manufacturing device capable of constructing three-dimensional structures by selectively fusing regions of deposited layers of powdered material. In particular, in a scan mirror configuration, the apparatus 100 manipulates a laser output optic relative to a build platform and selectively outputs a beam of energy toward a rotating mirror, which projects the intermittent energy beam onto a lens which subsequently focuses the beam onto the layer of material deposited over the build platform 112 to selectively melt areas of the powdered material, thereby “fusing” select areas of the layer of the powdered material. In a gantry configuration, the apparatus 100 manipulates the laser output optic relative to the build platform 112 and selectively outputs a beam of energy directly toward the layer of material deposited over the build platform 112 to selectively melt areas of layer of the powdered material. In either configuration, the apparatus 100 subsequently implements similar methods to project a second energy beam onto select fused areas of the layer of powdered material to anneal these areas.

The apparatus 100 includes multiple laser diodes (or electron guns or other energy beam generator) and/or multiple laser output optics to enable simultaneous projection of multiple discrete energy beams toward a layer of powered material to simultaneously preheat, melt, and/or anneal multiple regions of the material. For example, the material dispenser 120 can dispense layer after layer of powered material, and the first and second actuators can cooperate to scan energy beams from the first laser output optic 141s and energy beams from the second laser output optic 142 over the build platform 112 to melt and then anneal, respectively, select regions of each layer before a subsequent layer is deposited thereover. The apparatus 100 can further incorporate multiple discrete layers diodes to generate multiple discrete energy (e.g., laser) beams, which can be simultaneously projected onto a layer of powered material, thereby enabling simultaneous fusion (or stress relief) of multiple areas of the layer of powered material. The multiple discrete laser diodes can also be grouped into an array (e.g., a close-pack array) to enable fusion (or stress relief) of a larger single area of the layer, or the multiple discrete energy beams can be grouped into a single composite beam of higher power. Therefore, the apparatus 100 can incorporate multiple relatively low-power laser diodes to achieve power (or energy) densities at laser sintering sites on layers of powdered material approximating power (or energy) densities of a single higher-power laser diode. The apparatus 100 can also implement multiple relatively low-power laser diodes to achieve a laser coverage area per unit time commensurate with a laser coverage area per unit time of a similar apparatus with a single higher-power laser diode. The apparatus 100 can similarly implement multiple relatively low-power laser diodes to achieve an energy density (e.g., based on energy beam power, spot size, and energy beam scan speed) commensurate with an energy density of a similar apparatus with a single higher-power laser diode. The apparatus 100 can further control output parameters of the various laser diodes to customize laser interaction profiles, energy densities, power, etc. at and around a laser sintering site, such as based on a material loaded into the apparatus 100, a temperature of a layer of powered material, a direction of travel of the energy beams across the layer, etc.

### 1.1 Build Chamber

The build chamber 110 of the apparatus 100 includes the build platform 112. Generally, the build chamber 110 defines a volume in which a part is additively constructed by selectively fusing areas of subsequent layers of powdered material. The build chamber 110 can therefore include the build platform 112 coupled to a vertical (i.e., Z-axis) actuator configured to vertically step the build platform 112 as additional layers of powdered material are deposited (and smoothed) over previous layers of material by the material dispenser 120.

In one implementation, the build chamber 110 defines a parallel-sided rectilinear volume, and the build platform 112 rides vertically within the build chamber 110 and creates a powder-tight seal against the walls of the build chamber 110. In this implementation, the vertical interior walls of the build chamber 110 can be mirror-polished or lapped to external vertical sides of the build platform 112 to prevent powdered material deposited onto the build platform 112 from falling passed its edges and to prevent horizontal disruption of powdered material dispensed across the build platform 112. Alternatively, the build platform 112 can include a scraper, a spring steal ring, and/or an elastomer seal that prevents powdered material from falling passed the build platform 112. The build platform 112 and vertical walls of the build chamber 110 can also be of substantially similar materials, such as stainless steel to maintain substantially consistent gaps between mating surfaces (or seals) of the build chamber no walls and the build platform 112 throughout various operating temperatures within the build chamber 110. However, the build chamber 110 and the build platform 112 can be any other material (e.g., aluminum, alumina, glass, etc.), any other shape (e.g., cylindrical), and/or mate in any other suitable way.

As described above, the build platform 112 can be coupled to a Z-axis actuator 154, which functions to move the build platform 112 vertically within the build chamber 110, as shown in FIG. 1. In particular, the Z-axis actuator 154 and/or the build chamber 110 can constrain the build chamber 110 along three degrees of rotation and two degrees of translation (i.e., along the X- and Y-axis). For example, the Z-axis actuator 154 can include a lead screw, ball screw, rack and pinion, pulley, or other suitable mechanism powered by a servo, stepper motor, or other suitable type of actuator. The Z-axis actuator 154 can also include a multi-rail and multi-drive system that maintains the build platform 112 in a substantially perpendicular position relative to the build chamber 110 walls, normal to a laser output optic or to the lens 160, and at a constant vertical position relative during selective melting of areas of one layer of powdered material by the laser diode(s).

In one implementation, the actuator positions the build platform 112 vertically within the build chamber 110 at resolution of 20 μm to 100 μm with an approximate step size of 2 μm-5 μm. The Z-axis actuator 154 can also leverage weight of additional layers of powdered material deposited over the build platform 112 during a part build routine to maintain a stable position of the build platform 112.

The build chamber 110, the build platform 112, the Z-axis actuator 154, and/or various other components of the apparatus 100 can be arranged within a housing, such as described in U.S. patent application Ser. No. 14/212,875 filed on 14 Mar. 2014, which is incorporated in its entirety by this reference. Furthermore, as shown in FIG. 1, the apparatus 100 can include a door 114 into the build chamber 110 such that, once construction of a part is completed within the build chamber 110, the door 114 can be opened for removal of the part, such as manually by a user or automatically by a robotic conveyor.

### 1.2 Material Handling and Material Dispenser

One variation of the apparatus 100 includes a powder system 180 supporting supply of powdered materials into the apparatus 100 and distribution of powdered material within the build chamber 110.

In one implementation, the powder system 180 includes a material cartridge defining a storage container for a particular type or combination of types of powdered materials for three-dimensional part construction within the build chamber 110. The material cartridge can be initially sealed (e.g., airtight) to maintain an internal atmosphere, thereby extending a shelf life of fresh powdered material within by preventing oxidation of the powdered material through contact with air. The material cartridge can also be resealable. For example, after being loaded into the apparatus 100, the cartridge can be opened, powdered material removed from the cartridge, an inert atmosphere reinstated within the cartridge, and the cartridge resealed once a part build is complete to prolong life of material remaining in the cartridge.

The cartridge can also include one or more sensors configured to output signals corresponding to a level of material within the cartridge, atmosphere type and/or quality within the cartridge, etc. For example, the material cartridge can include a resistance sensor, a capacitive sensor, an inductive sensor, a piezoelectric sensor, and/or a weight sensor configured to detect material volume, material type, and atmosphere within the cartridge. The cartridge can also include additional sensors configured to detect (basic) material properties, such as density, fuse or melting temperature, emissivity, etc. and/or to verify that a material loaded into the cartridge matches a material code stored on or within the cartridge. The cartridge can further include temperature, humidity, and/or gas sensors to monitor life and quality of material stored within the cartridge over time, such as on a regular (e.g., hourly) basis, continually, or when requested automatically by the apparatus 100 or manually by an operator.

The cartridge can further include a wireless transmitter configured to transmit corresponding cartridge data, such as material level, atmosphere type and quality, contained material type, material properties of a contained material, material age, material source or destination, build or apparatus installation history, lot number, manufacturing date, etc. For example, the cartridge can include an RFID tag or a Bluetooth communication module coded with a pointer to a computer file specific to the cartridge, containing these data, and stored on a remote database. Alternatively, the cartridge can store any of these data locally and transmit these data directly to the apparatus 100 before or during a part build to support part construction. Alternatively, the cartridge can transmit a unique identifier to the apparatus 100, and the apparatus 100 can interface with a database, remote server, or computer network to retrieve relevant material and/or cartridge data assigned to or associated with the unique identifier. For example, each cartridge within a set of cartridges containing powdered materials for part construction can be assigned a unique identifier to track the cartridges through a logistics supply chain, to verify material authenticity, to monitor cartridges usage rates, etc. Additionally or alternatively, the material cartridge can communicate with the apparatus 100 over an electrical (i.e., wired) interface when loaded into the apparatus 100. The electrical interface can thus support communication of data between the apparatus 100 (e.g., the processor) and the material cartridge.

Furthermore, the material cartridge can include a processor configured to monitor sensor outputs, to correlate sensor outputs with relevant data types (e.g., material temperature, internal material volume), to trigger alarms or flags for material mishandling, to handle communications to and/or from the apparatus 100, etc.

In one implementation, the material cartridge includes memory or a data storage module that stores material-related data and/or data uploaded onto the cartridge by the apparatus 100 before, during, and/or after part construction with material sourced from the cartridge. Data transmitted to and/or from the cartridge can also be encoded, encrypted, and/or authenticated to enable verification or authorization of use of the cartridge, to identify a compromised material cartridge, to secure a corresponding material supply chain, to detect material counterfeiting activities, etc.

The material cartridge includes an (resealable) output, and the apparatus 100 can be extracted material from this output for dispensation into the build chamber no. For example, material can be extracted from the cartridge mechanically, such as with a lift, gravity feed, a rotational screw lift or screw drive, a conveyor, etc. Material can alternatively be removed from the cartridge pneumatically or in any other suitable way.

The material dispenser 120 of the apparatus 100 is thus configured to distribute a layer of powdered material over the build platform 112. Generally, once a cartridge is installed in the machine and part construction initiated, the material dispenser 120 draws powdered material out of the material dispenser 120 and distributes the powdered material across the build platform 112 in a first layer of substantially constant depth (e.g., thickness). The laser diodes, laser output optics, and actuators subsequently cooperate to project one or more energy beams onto the deposited layer to preheat, melt, and/or anneal select areas of the layer of powdered material, and the Z-axis actuator 154 indexes the build platform 112 vertically downward once a scan over the first layer is completed. The material dispenser 120 then distributes a second layer of powdered material over the first layer of powdered material and the laser diodes, laser output optics, and actuators again cooperate to project one or more energy beams onto the deposited layer to preheat, melt, and/or anneal select areas of the second layer of powdered material. These elements of the apparatus 100 can repeat these steps until all layers of a part under construction within the apparatus 100 are dispensed and corresponding areas of the layers are fused into a prescribed geometry.

Generally, for each additional build layer of the part during construction, the material dispenser 120 meters a particular volume, mass, and/or weight, etc. of material from the cartridge and distributes this amount of powdered material evenly over the build platform 112 (or over a preceding layer of material) to yield a flat, level, and consistent build surface at a consistent and repeatable distance from the laser output optic. For example, the material dispenser 120 can include a material leveler configured to move across the build chamber 110 to distribute powdered material evenly across the build platform 112. The material dispenser 120 can include multiple replaceable blades, a fixed permanent leveling blade, a vibration system, or any other suitable material leveling system. The material dispenser 120 can also implement closed-loop feedback based on a position of a blade and/or a power consumption of a leveler actuator during a material leveling cycle to prevent disruption of previous layers of material and/or to prevent damage to previously-fused regions of prior material layers.

The material dispenser 120 can also recycle remaining material from the build chamber 110 once the build cycle is complete. For example, once the build cycle is complete, the material dispenser 120 can collect un-melted powder from the build chamber 110, pass this remaining powder through a filtration system, and return the filtered material back into the material cartridge. In this example, the material dispenser 120 can include a vacuum that sucks remaining powdered material off of the build platform 112, passes this material over a weight-based catch system (or filter), and drops the filtered material into an inlet at the top of the cartridge. Furthermore, as this remaining material is filtered, powders that fall outside of a particle size requirement or particular size range can be removed from a return supply to the cartridge.

Alternatively, once the build cycle is complete, the material dispenser 120 can drain unused powder from the build chamber 110 via gravity, filter the powder, and return the filtered powder to the powder cartridge via a mechanical lift system. For example, the build chamber 110 can define drainage ports proximal its bottom (e.g., opposite the laser output optics and/or the lens 160) such that, to drain remaining un-melted material from the build chamber 110, the build platform 112 is lowered passed a threshold vertical position to expose the drainage ports to the material. The material can thus flow out of these ports via gravity and can then be collected, filtered, and returned to the cartridge, as shown in FIG. 1. Furthermore, in this example, a blower arranged over the build platform 112 or a vacuum coupled to the drainage ports can draw any remaining material through the drainage ports and/or decrease drainage time. Additionally or alternatively, the material dispenser 120 can implement a screw, conveyor, lift, ram, plunger, and/or gas-, vibratory, or gravity-assisted transportation system to return recycled powdered material to the cartridge.

In this variation of the apparatus 100, the powder system 180 can define a closed powder system 180 that substantially reduces or eliminates human (e.g., operator) interaction with raw powdered materials for part construction within the apparatus 100. This closed powder system 180 can include or accept multiple powder filters, powder recycling systems, material dispensers, etc. The apparatus 100 can also support installation of multiple material cartridges simultaneously to enable use of combinations of materials within a single part, such as on a per layer basis.

### 1.3 Laser Output Optics

The first laser output optic 141 of the apparatus 100 is configured to output a first energy beam toward the mirror. Similarly, the second laser output optic 142 of the apparatus 100—adjacent the first laser output optic 141—is configured to output a second energy beam toward the mirror. Generally, the laser output optics are configured to focus corresponding energy beams on their way toward the build platform 112 to selectively heat, “fuse” (or melt), anneal (e.g., stress-relieve), and/or harden or heat treat select areas of the layer of powdered material.

In a scan mirror configuration described below, the first and second laser outputs are coupled to the first actuator 151. In one example, the first actuator 151 scans the first and second laser output optics across and parallel to an axis of an elongated rotating mirror (actuated by the second actuator 152), which reflects the corresponding first and second energy beams onto the lens 160 below. In another example, the first and second laser output optics are arranged within a housing with the rotating mirror and project the corresponding energy beams onto the rotating mirror (powered by the second actuator 152) as the first actuator 151 scans the housing over the build platform 112. Thus in this configuration, the laser output optics function to focus corresponding energy beams onto the mirror, which, while rotating, scans the energy beams across the lens 160. Alternatively, in a gantry configuration described below, the first and second laser output optics project the corresponding energy beams directly onto the layer of powdered material. For example, the first and second laser output optics can be supported on a table coupled to the first and second actuators, the first actuator 151 configured to move the table in one direction (e.g., along an X-axis), and the second actuator 152 configured to move the table in another direction (e.g., along a Y-axis perpendicular to the X-axis). Thus, in this configuration, the laser output optics function to focus the corresponding energy beams onto the surface of the layer of powdered material (i.e., at the laser sintering site).

In one variation, the apparatus 100 include a set (e.g., multiples) of discrete laser diodes configured to output discrete energy beams that are focused onto the mirror 130 by corresponding laser output optics. For example, the apparatus 100 can include multiple Blue Ray lasers (and/or other relatively low-power laser diodes or energy beam generators), each generating an energy beam of between 0.5 W and 2 W (one half and two Watts) and coupled to a corresponding laser output optic via a corresponding fiber optic cable configured to accommodate changes in distance between the laser diode and the corresponding laser output optic as the first actuator 151 (and/or the second actuator 152) displaces the laser output optic. The apparatus 100 can additionally or alternatively include a bar diode 170 outputting multiple discrete energy beams to the laser output optics via a multi-cored fiber optic cable. The set of laser output optics can thus project discrete energy beams onto the mirror 130 in the scan mirror configuration or directly toward the build platform 112 in the gantry configuration.

In one implementation, the set of discrete laser diodes includes a first discrete laser diode configured to output the first energy beam and coupled to the first laser output optic 141 by a first fiber optic cable 173. In this variation, the apparatus 100 also includes a second discrete laser diode configured to output the second energy beam and coupled to the second laser output optic 142 by a second fiber optic cable 174. The apparatus 100 can similarly include a set of discrete laser diodes, wherein each laser diode in the set of laser diodes is configured to generate a discrete energy beam and is coupled by a fiber optic cable to a laser output optic in a set of laser output optics. In the scan mirror configuration, the set of laser output optics can thus output discrete energy beams toward the mirror 130 and the first actuator 151 can translate the set of laser output optics with the first laser output optic 141 and the second laser output optic 142 relative to the build platform 112 such that the mirror 130 reflects the set of discrete energy beams onto the lens 160, the lens 160 thus focusing the discrete energy beams toward (and substantially normal to) the powdered material over the build platform 112. Similarly, in the gantry configuration, the set of laser output optics can output discrete energy beams directly toward the layer of powdered material, and the first and second actuators can translate the set of laser output optics over the layer of powdered material.

In this variation, a laser diode (in the set of laser diodes) can output a discrete Gaussian beam, and a corresponding laser output optic can include a refractive beam shaper configured to collimate the corresponding energy beam output by the laser diode. For example, each laser output optics in the set of laser output optics can include a refractive beam shaper that transforms a circular Gaussian beam into a square flattop beam, and the set of laser output optics can cooperate to project a square array of discrete energy beams onto the mirror, which reflects the square array of energy beams onto the lens 160, which then focuses the square array of energy beams onto and substantially normal (e.g., within fifteen degrees (15°) of normal) to the layer of powdered material, such as shown in FIG. 3A. In another example, each laser output optics in the set of laser output optics includes a refractive beam shaper that transforms a circular Gaussian beam into a round flattop beam, and the set of laser output optics can thus cooperate to project a close-pack array of discrete energy beams onto the mirror, which reflects the close-pack array of energy beams onto the lens 160, which then focuses the close-pack array of energy beams onto and substantially normal to the layer of powdered material, such as shown in FIG. 3B.

Alternatively, the laser diode, the laser output optics, the mirror, and the lens 160 can cooperate to focus multiple discrete Gaussian beams onto the layer of powdered material. For example, the lens 160 can project each discrete Gaussian energy beam onto a corresponding spot on the layer of powdered material, wherein the spots overlap in a close-pack array (shown in FIG. 4C), wherein the spots overlap in a square array (shown in FIG. 4D), or wherein the spots are disjoint (i.e., do not overlap) in a close-pack array (shown in FIG. 4B) or square array (shown in FIG. 4A). However, the lens 160 can shape one or more discrete energy beams output by the laser diodes(s) into any other form.

In this variation, the laser diodes can output energy beams of different wavelengths, such as to avoid interference between energy beams in the form of fringe patterns of high and low incident energy on the layer of powdered material. For example, the first laser diode 171 can generate the first energy beam at a first wavelength of 400 nanometers, and the second laser diode 172 can generate the second energy beam at a second wavelength of 410 nanometers. In this example, the apparatus 100 can include multiple discrete laser diodes, each generating a discrete energy beam of either 400 nanometers (e.g., w₁) or 410 nanometers (e.g., w₂), and the corresponding laser output optics can be grouped such that a square array of discrete energy beams is projected onto a surface of the layer of powdered material with no two adjacent energy beams of the same wavelength, such as shown in FIG. 4A. In a similar example, the apparatus 100 includes multiple discrete laser diodes, each generating a discrete energy beam of one of 390 nanometers (e.g., w₁), 400 nanometers (e.g., w₂) and 410 nanometers (e.g., w₃) and the corresponding laser output optics are be grouped such that a close-pack array of discrete energy beams is projected onto the surface of the layer of powdered material with no two adjacent energy beams of the same wavelength, such as shown in FIG. 4B. In one implementation, the laser diodes output energy beams within the spectrum of blue light (e.g., 360 nanometers to 480 nanometers), a range of wavelengths over which the powdered material (e.g., a metal) adsorbs energy from the energy beam relatively efficiently. However, the laser diodes can generate the energy beams of any other wavelength(s).

In this variation, the laser diodes can also generate energy beams of different power (or energy) density. From hereinafter, unless otherwise stated, the power density of an energy beam can be defined as the power per unit area at a laser interaction zone (or laser sintering site) at which the energy beam is incident on a topmost layer of powdered material deposited over the build platform 112. For example, the first laser diode 171 can generate the first energy beam of a first power (or first power density), and the second laser diode 172 can generate the second energy beam of a second power (or first second density) density less than the first power (or first power density). In particular, in this example, the first energy beam can yield a relatively high power density at an area of the layer of powdered material (i.e., the laser sintering site) to fuse (or melt) powdered material within the area, and the second energy beam—of a lower power density—can follow the first energy beam to anneal the fused material at the area of the layer, as described below.

The apparatus 100 can additionally or alternatively include multiple substantially similar laser diodes (or one or more bar diode 170s) with outputs grouped by a multi-cored fiber optic cable and combined at a single laser output optic to yield a single energy beam of higher power and/or higher energy density than a single laser diode. In this implementation, the laser diodes can be phase together limit destructive interference at the single laser output optic, or the set of laser diodes can be selectively phased to modify a size, shape, power density, energy profile, or other property of the composite energy beam output from the laser output optic.

As described below, a processor within the apparatus 100 can control operating wavelengths, powers, power densities, energy densities, etc. of the laser diodes, such as independently or in combination. For example, the processor can set the laser diodes to operate at particular wavelengths to limit fringe effects (i.e., destructive interference patterns) proximal the laser sintering site. In another example, the processor can modulate power outputs of the laser diodes to achieve a range of focal lengths and/or focal areas at the laser sintering site, such as for a composite energy beam assembled from multiple discrete energy beams. In one implementation, the apparatus 100 controls the melt pool size, melt pool depth, and/or material temperature within the melt pool, etc. at a current laser sintering site by modulating the energy (or power) density output of select laser diodes in the set of laser diodes (e.g., by leveraging constructive and destructive interference between the energy beams output from the laser diodes via the laser output optics). Thus, by balancing a power and/or energy output from each laser diode in the set, the processor can control properties of the melt pool and annealing zones in any around the laser sintering site at the layer of powdered material.

Each laser output optic in the set of laser output optics can also include an adjustable focusing system configured to (e.g., automatically or through manual adjustment) modify a focal length and/or a focal area of a corresponding energy beam projected toward the mirror 130 or directly toward the laser sintering site. The adjustable focusing system can also accommodate temperature, pressure, and/or atmospheric changes within the build chamber 110, flexure of the housing or build chamber (e.g., due to a physical impact), etc. For example, the adjustable focusing system can adjust a focus of a corresponding energy beam onto the mirror 130 based on a detected distance between laser output optic and the mirror, between the mirror 130 and the lens 160, and/or between the lens 160 and the top surface of the laser of powdered material, such as to adjust a size of the corresponding laser spot on the surface of the layer of powdered material. In one example, the set of laser output optics focus corresponding energy beams from corresponding laser diodes toward a singular point on the mirror 130 (or toward a singular point on the laser sintering site) to yield a composite energy beam of substantially high power density at the singular point. In another example, the set of laser output optics focus corresponding energy beams from corresponding laser diodes into a particular arrangement of beam interaction sites on the mirror 130 or directly on the layer of powered material). Each focusing systems can thus manipulate a focal length and/or a focal area of a corresponding energy beam, and the set of focusing systems can thus be controlled to manipulate the location, size, power density, and/or energy density, etc. of corresponding discrete energy beams projected onto the mirror, onto the lens 160, or onto the layer of powered material. For example, processor can further manipulate the adjustable focusing systems independently or in combination.

The apparatus 100 can further incorporate holographic optics, small, high-speed imagers, rapid adjustment focusing systems (e.g., a voice coil motor), focus reference systems with optical over and under focus detection, etc. to support optical feedback techniques to maintain constant or dynamic target energy beam focusing during construction of a part within the build chamber 110. The apparatus 100 (e.g., a processor within the apparatus 100) can additionally or alternatively manipulate a voltage, a current, a rise time, a fall time, a pulse time, a laser pulse profile, a power, a duration, a wavelength, etc. of one or more laser diodes within the apparatus 100. The apparatus 100 can further incorporate power control, power factor, and/or power stabilization capabilities to control the laser diode(s) and/or the laser output optic(s).

### 1.4 Scan Mirror Configuration

In one configuration, the apparatus 100 includes the mirror, which is arranged over the build platform 112 and defines a mirrored planar surface, and the second actuator 152, which is configured to maneuver the mirror 130 to scan an energy beam—projected from a laser output optic onto the mirror 130—across the lens 160 (e.g., along a first axis). In this configuration, the lens 160 is arranged between the mirror 130 and the build platform 112 and is configured to project the energy beam toward and substantially normal to the build platform 112. Furthermore, in this configuration, the first actuator 151 of the apparatus 100 is configured to maneuver the first laser output optic 141 and the second laser output optic 142 relative to the build platform 112 to scan the corresponding energy beam across the build platform 112 (e.g., along a second axis perpendicular to the first axis). In particular, in this configuration, the laser output optics project corresponding energy beams onto the mirror, and the mirror 130 can function to reflect one or more discrete energy beams onto the lens 160, which then projects the discrete energy beams toward the build platform 112 to heat, fuse, and/or anneal select areas of the onto the layer of powdered material below.

In this configuration, the mirror 130 includes a polygonal cylinder defining a set of planar mirrored surfaces or “facets,” and the second actuator 152 rotates the mirror 130 about a central axis of the polygonal cylinder. For example, the polygonal cylinder can include a hexagonal cylinder with six planar mirrored facets arranged equi-radially about the central axis of the cylinder. As the cylinder rotates, the incident angle of an energy beam projected from a laser output optic onto a first mirrored facet changes with the arcuate angle of the cylinder. The energy beam is then reflected from the first mirrored facet onto the lens 160 at (approximately) the incident angle such that a point at which the energy beams meets the lens 160 moves (linearly) along the lens 160 as the arcuate angle of the first mirrored facet changes. For example, the mirror 130 can scan the energy beam from proximal a first end of the lens 160 to an opposite end of the lens 160 along a linear path during an arcuate range of the cylinder in which the first mirrored facet is in a view of the laser output optic (e.g., 60° for a hexagonal cylinder). Furthermore, as the cylinder continues to rotate and the first mirrored facet moves outside a view of the laser output optic(s), a second mirrored facet comes into view of the laser output optic(s). The second mirrored facet then initially reflects the energy beam onto the lens 160 proximal the first end of the lens 160 and scans the energy beam along the lens 160 toward the second end of the lens 160 are the cylinder continues to rotate.

In one implementation, the mirrored polygonal cylinder is elongated and rotates about a central axis over the lens 160, wherein the central axis of the mirror 130 and the lens 160 are fixed over the build chamber 110. In this implementation, the first actuator 151 can index the laser output optic(s) laterally along the axis of the cylinder upon each subsequent transition from one mirrored facet to an adjacent mirrored facet of the mirror 130 into view of the laser output optic(s). Thus, in this implementation, the first actuator 151 can shift the position of the laser output optic(s) along the axis of the mirror 130 to scan subsequent adjacent linear regions of a current topmost layer of powdered material over the build platform 112. For example, the first actuator 151 can include a mechanized linear slide supporting the laser output optic(s) over the lens 160, and the first actuator 151 can step the laser output optic(s) through a sequence of lateral positions as the mirror 130 completes each subsequent scan of the energy beam across the lens 160 (e.g., as each facet completes a full range of view across the laser output optics, such as for each 60° rotation of the polygonal cylinder with six mirrored facets). In particular, as in this example, the first actuator 151 can translate the laser output optic along the mirror 130 with the corresponding energy beam at a substantially constant angle to the axis of the mirror.

In a similar implementation, the mirror 130 defines a short polygonal cylinder with mirrored facets, the laser output optic(s) is coupled (e.g., set at a fixed distance and orientation) relative) to the mirror, the lens 160 is fixed over the build chamber 110, and the first actuator 151 moves the laser output optic(s) and the mirror 130 in tandem linearly along a first across over the lens 160. In particular, the first actuator 151 can index the laser output optic(s) and the mirror 130 parallel to the central axis of the polygonal cylinder as (or just before) each subsequent mirrored facet of the mirror 130 comes into view of the laser optic. In this implementation, the first actuator 151 can scan the laser output optic(s) and the mirror 130 in one direction across the lens 160 as the second actuator 152 rotates the mirror 130 to scan an energy beam from the laser output optic in a second direction—perpendicular to the first direction—across the lens 160, the first and second actuators thus cooperating to manipulate the energy beam over a full (e.g., rectilinear) work area of the lens 160. The lens 160 can subsequently internally refract the energy beam such that the beam is output toward and substantially normal to the surface of the layer of powdered material below.

In the foregoing implementations in which the first actuator 151 indexes the laser output optic(s) and/or the mirror 130 across the lens 160 with the energy beam at a substantially constant angle to the central axis of the polygonal cylinder, the lens 160 can include an F-theta lens of a two-dimensional extruded form. The lens 160 can thus internally refract an energy beam incident on an input side of the lens 160 (i.e., adjacent the mirror) at an acute angle and output the energy beam toward the build platform 112 in a direction substantially normal to the surface of the layer of powdered material below.

Alternatively, the first actuator 151 can tilt the mirror 130 and laser output optic as an assembly along a first axis (e.g., an axis parallel to the surface of the build platform 112) to scan the energy beam in a first direction across the lens 160, and the second actuator 152 can rotate the mirror 130 to reflect an energy beam from the laser output optic toward the lens 160 along a second direction (e.g., perpendicular to the first direction). In one example, the first actuator 151 includes a servo motor, and the laser output optic(s), the mirror, and the second actuator 152 are mounted directly on or coupled a rotary output shaft of the servo motor such that actuation of the servo motor tilts the laser output optic, mirror, and second actuator assembly. In this implementation, the lens 160 can include an F-theta lens of an annular form. The lens 160 can thus refract an energy beam incident on the lens 160 at an angle (e.g., between 0° and ±28° from normal) and output the energy beam toward and substantially normal to the build platform 112.

Yet alternatively, the first actuator 151 can scan the energy beam across the rotating mirror over a range of angle. In a first example, the first actuator 151 includes a galvanometer optical scanner, wherein the laser output optic(s) projects an energy beam onto the galvanometer, the galvanometer scans the energy beam in a first direction along the mirror, the mirror 130 scans the energy beam in a second direction across the lens 160, and the lens 160 “straightens” the energy beam toward the layer of powdered material below. In another example, the first actuator 151 includes a servo motor, and the laser output optic(s) mounted on or coupled to a rotary output shaft of the servo motor such that actuation of the servo motor tilts the laser output optic relative to the mirror, thus scanning the energy beam from the laser output optic across and along the central axis of the mirror, and the mirror 130 can further reflect the incident energy beam toward the lens 160. In this implementation in which the first actuator 151 tilts or rotates the laser output optic(s) relative to the lens 160, the lens 160 can again include an F-theta lens of annular form such that the lens 160 internally refracts an energy beam incident on an input side of the lens 160 at a compound angle and outputs the energy beam toward the build platform 112 in a direction substantially normal to the surface of the layer of powdered material below.

Furthermore, in the foregoing implementations, the lens 160 can be fixed over the build platform 112, such as suspended over the build chamber 110 between the build platform 112 and the laser output optic(s). For example, the lens 160 can be installed through a sealed ceiling over the build chamber 110, the lens 160 defining a window for the energy beam to pass from the mirror 130 into the build chamber 110. The lens 160 can thus cooperate with the ceiling to seal (i.e., isolate) the mirror 130 and the laser output optics from the build chamber 110, such as from airborne particulate (e.g., dust) generated within the build chamber 110 during construction of a part. Alternatively, the mirror 130 can be open to the build chamber 110, and the apparatus 100 can flow an inert gas, such as nitrogen or argon, around the mirror 130 to isolate the mirror 130 from an environment in the rest of the build chamber 110. For example, by flowing inert gas around the mirror 110, the apparatus 100 can substantially inhibit deposition or condensation of vaporized powdered material onto the lens, which may otherwise negative transmission of the energy beam from a laser output optic through the lens 160. The apparatus 100 can similarly flow inert gas around the lens 160 to isolate the lens 60 from the remainder of the build chamber. The mirror 130 and/or the lens 160 can thus me isolated from an environment of the build chamber 110 by a physical structure (e.g., a rigid wall or housing) or by a fluid (e.g., laminar flow argon of argon around the mirror 130).

In an alternative implementation, the second actuator 152, the mirror, the lens 160, and the laser output optic(s) are assembly in a unit actuated by the first actuator 151. As shown in FIG. 5 one variation of the apparatus 100 includes a housing 140 cooperating with the lens 160 to enclose the first laser output optic 141, the second laser output optic 142, the mirror, and the second actuator 152, and wherein the first actuator 151 is configured to displace the housing 140 linearly across the build platform 112. The housing 140 and the lens 160 can thus enclose the mirror, the second actuator 152, and the first and second laser output optics in a “laser head,” and the first actuator 151 can translate the laser head (linearly) over the build platform 112 (e.g., in a first direction) as the second actuator 152 scans the first and second energy beams across the lens 160 and thus onto the layer of powdered material (e.g., in a second direction perpendicular to the first direction). For example, in this variation, the lens 160 can include an F-theta lens of a two-dimensional extruded form configured to focus an energy beam—swept linearly across the lens 160 through a range of incident angles (e.g., −28° to 28°) by the mirror 130—along a linear path on and substantially normal to the layer of powdered material. In this example, the mirror 130 and lens cooperate to sweep the energy beam across the linear path that is parallel to a second direction, and, once the linear path is completed, the first actuator 151 can index the laser head along a first direction perpendicular to the second direction over the build platform 112.

In the foregoing implementation, one or more laser diodes can be arranged within the housing 140 and generate corresponding energy beams locally within the laser head as the laser head moves through subsequent positions over build chamber. Alternatively, each laser diode can be arranged remotely within the apparatus 100 and coupled to a corresponding laser output optic within the laser head via a flexible (e.g., elastic) fiber optic cable passing through the housing 140. Thus, in this implementation, the housing 140 can seal the laser output optic(s), the mirror, and the interior surface of the lens 160, etc. within, thus isolating these optical components from the environment of the build chamber 110.

Furthermore, in the foregoing implementation, the apparatus 100 can move the laser head to a “home position” at the beginning and/or at the end of a part build cycle. For example, for the apparatus 100 that includes a door 114 into the build chamber 110 through which a user may remove a completed part, the first actuator 151 can move the laser head to a far wall of the build chamber 110 opposite the door 114 when a part build sequence is complete to limit obstruction by the laser head of part removal by a user. In particular, by moving the laser head to this home position, likelihood of contact between a user and the laser head—which could damage or upset the laser head—can be substantially minimized. The apparatus 100 can further include a cover, door, alcove, or other feature that contains and/or shields the laser head in the home position.

In a similar implementation, the first actuator 151 displaces the laser head (e.g., the laser output optic(s), the mirror, and/or the lens 160, etc.) along a first direction, the second actuator 152 rotates the mirror 130 to scan the laser beam across the lens 160 in a second direction, and the apparatus 100 includes a third actuator configured to move the laser head in a third direction. For example, the first and third actuators can cooperate to define an mechanized X-Y table, wherein the first actuator 151 indexes the laser head along a Y-axis of the apparatus 100 (e.g., from the front of the build chamber 110 proximal the door 114 to the back of the build chamber 110 opposite the door 114), and wherein the second actuator 152 moves the laser head along an X-axis of the apparatus 100 perpendicular to the Y-axis (e.g., back and forth between the left side of the build chamber 110 and the right side of the build chamber 110). In this example, the build platform 112 can define a 200 mm by 200 mm build area, and the second actuator 152 can rotate a hexagonal mirrored cylinder (i.e., the mirror) through a 60° rotation to scan the energy beam across the lens 160 such that the lens 160 projects the energy beam along a 20 mm-deep region of the topmost layer of powdered material, wherein the 20 mm-deep region is parallel to the Y-axis of the apparatus 100. Once the mirror 130 completes the 60° rotation—(and the lens completes a scan across the ˜20 μm deep region of the layer of powdered material), the third actuator indexes the laser head forward along the X-axis, such as by a distance equivalent to a width of the energy beam (or a set of energy beams) projected onto the surface of the layer. The second actuator 152 continues to rotate the mirror, a subsequent facet of the mirror 130 thus similarly projecting the energy beam across an adjacent 20 mm-deep region of the layer of powdered material below throughout a subsequent 60° rotation of the mirror. The third actuator can continue to index the laser head along the X-axis as scans along subsequent 20 mm-deep regions are completed until the an X-axis travel limit (over the build platform 112) is reached, at which point the first actuator 151 can index the laser head forward along the Y-axis, such as by 20 mm, the depth of each region scanned by the lens 160. The, second actuator, the lens 160, and the third actuator can thus cooperate to similarly scan the energy beam over the adjacent 20 mm by 200 mm area of the topmost layer of powdered material below, and the first actuator 151 can index forward again as a scan over each such adjacent 20 mm by 200 mm area of the layer is completed. Once a scan over the layer is completed, the material dispenser 120 can distribute a new layer of powdered material over the previous layer(s) of powdered material, and the foregoing process can repeat to similarly scan the energy beam over each subsequent layer of powdered material until a part is completed within the build chamber 110. Thus, as in this implementation, the apparatus 100 can include a third actuator that cooperates with the first and second actuators to scan one or more energy beams across layers of powdered material supported by the build platform 112. However, the build platform 112 and build chamber can be of any other size or form, and the first, second, and third actuators can cooperate to scan the energy beam over linear regions of any other depth and to index the laser head over any X- and/or Y-distance, such as based on a width of a single energy beam or an effective width of a group of energy beams projected onto a surface of a topmost layer of powdered material on the build platform 112 or based on a maximum incident angle of an energy beam on the interior of the lens 160 at which the lens 160 can output flat field at the image plane. Furthermore, in this example, the first actuator 151 and the third actuator can move the laser head to an extreme corner or edge of the build chamber 110—such as over a right-rear corner of the build platform 112 opposite the door 114 into the build chamber 110—such that the laser does not substantially obstruct retrieval of a part from the build chamber 110 upon completion of a part build cycle. Thus, in this implementation, the apparatus 100 can include elements and execute process movements from both the scan mirror configuration described above and the gantry configuration described below.

As described below, the apparatus 100 can include multiple laser diodes that generate discrete energy beams, and the apparatus 100 can include multiple laser output optics that focus the discrete energy beams onto the mirror, which reflects the discrete energy beams onto the lens 160 and then onto the layer of powdered material below. Thus, in any of the foregoing implementations and examples, the laser diodes, the laser output optics, the mirror, and the lens 160 can cooperate to project multiple discrete energy beams of the same, similar, or dissimilar power or energy density onto the layer of powdered material at disjoint or overlapping spots of the same, similar, or dissimilar sizes, as described below. For example, the lens 160 can focus the first energy beam at a first spot over the layer of powdered material and focus the second energy beam at a second spot over the layer of powdered material, wherein the first spot falls within a boundary of the second spot and is of a power density greater than a power density of the second spot. In this example, the power density across the first spot can be sufficient to locally melt powdered material as the first energy beam is swept across the layer, and the power density across the second spot can be substantially lower than at the first spot such that a region of the second spot leading the first spot preheats the powdered material and such that a region of the second spot trailing the first spot slows cooling at just-melted powdered material as the second energy beam is swept across the layer with the first energy beam.

Furthermore, in the foregoing configuration, the apparatus 100 can include multiple lens, each paired with a mirror, a pair of actuators, and one or more laser output optics and/or laser diodes, and the apparatus 100 can maneuver the various lens in tandem or independently over the build platform 112. For example, the apparatus 100 can include a set of substantially similar adjacent laser heads arranged linearly along a first axis of the build chamber 110, and the first actuator 151 can index the set of laser heads over the build platform 112 along a second axis perpendicular to the first axis. However, in this configuration, the apparatus 100 can include any other number of mirrors, lenses, actuators, laser output optics, and/or laser diodes arranged in any other way to project one or more energy beams onto subsequent layers of powdered material supported by the build platform 112 to selectively heat, fuse, and/or anneal select regions of powdered material during a part build cycle.

### 1.5 Gantry Configuration

As shown in FIGS. 2 and 6, in a gantry configuration of the apparatus 100, the first laser output optic 141 is configured to output a first energy beam toward the build platform 112 and substantially normal to the layer of powdered material, and the second laser output optic 142—adjacent the first laser output optic 141—is configured to output a second energy beam substantially parallel to and offset from the first energy beam. Generally, in this configuration, the first and second laser output optics focus the first and second energy beams, respectively, directly onto the layer of powdered material (i.e., rather than onto a rotating mirror), and the first actuator 151 maneuvers the first laser output optic 141 and the second laser output optic 142 along a first axis parallel to the layer of powdered material, and the second actuator 152 maneuvers the first laser output optic 141 and the second laser output optic 142 along a second axis parallel to the layer of powdered material and perpendicular to the first axis.

In one implementation of this configuration, the first laser output optic 141 and the second laser output optic 142 are suspended from a gantry, and the first actuator 151 and the second actuator 152 cooperate to scan the gantry over the build platform 112. For example, the first actuator 151 can scan the gantry along an X-axis of the build chamber 110, and the second actuator 152 can index the gantry along a Y-axis of the build chamber 110 when the first actuator 151 reaches an X-axis travel limit. Furthermore, in this configuration, the apparatus 100 can include a third laser output optic suspended from the gantry, the third laser output optic configured to output a third energy beam substantially normal to the layer of powdered material and offset from the first energy beam and the second energy beam in a staggered configuration. However, any other number of laser output optics can be suspended from the gantry, and the laser output optics can be spaced across the gantry to project corresponding energy beams onto disjoint or overlapping spots of the same, similar, or dissimilar sizes and power densities on the surface of a layer of powdered material over the build platform 112 as described below. For example, the laser output optics can be arranged in fixed positions on the gantry to focus a series of energy beams in a particular array (e.g., a close-pack array of circular energy beams) at a particular distance below the gantry, the particular gantry corresponding to a working distance between the laser output optics and a surface of a topmost layer of powdered material dispensed onto the build platform 112. Alternatively, each laser output optic can be coupled to a focusing system (described above) and/or to an actuatable positioning system such that corresponding energy beams can be focused at varying distances and/or repositioned on a small scale over the build platform 112, such as to alter intersections, sizes, and/or relative positions of laser spots projected onto a layer of powdered material below. Furthermore, each laser output optic arranged on the gantry can be coupled to a corresponding laser diode—arranged remotely within the apparatus 100—via a flexible singular fiber optic can or a multi-cored fiber optic cable (shown in FIG. 5), such as described above. Alternatively, the laser diode(s) can be coupled directly to the corresponding laser output optic(s) and supported directly off of the gantry.

In this implementation, the first and second actuators function to maneuver (e.g., scan) a laser output optic(s) across a plane parallel to and over the build platform 112. In particular, as the first and second actuators move to various positions across the plane over the build chamber 110, a laser diode within the apparatus 100 intermittently generates an energy beam that is communicated toward a topmost layer of powdered material on the build platform 112 by a corresponding laser output optic to selectively heat, fuse, and/or anneal areas of the layer of powdered material. Furthermore, with the laser output optic(s) (non-transiently) focused to a particular vertical depth over the build platform 112, the Z-axis actuator 154 supporting the build platform 112 can maintain each subsequent topmost layer of powdered material at a particular corresponding vertical distance from the laser output optic(s).

In one implementation, the apparatus 100 includes a computer-numeric control X-Y table. For example, each of the first and second actuators can include a lead screw, a ball screw, a rack and pinion, a pulley, or other power transmission system driven by a servo, stepper motor, or other electromechanical, pneumatic, or other actuator. In one example implementation, the first actuator 151 includes a pair of electromechanical rotary motors configured to drive parallel lead screws supporting each side of the second actuator 152, which includes a single stepper motor configured to drive the gantry with the along a second rail system over the build platform 112.

Thus, in the foregoing configurations, implementations, and examples, the apparatus 100 can include multiple laser diodes and multiple laser output optics configured to simultaneously project multiple energy beams directly or indirectly (e.g., via a mirror and a lens) onto a topmost surface of powdered material dispensed across the build platform 112. Thus, the apparatus 100 can preheat, fuse, and/or anneal a substantially large area of the surface of the dispensed powdered material per unit time despite application of substantially low-power laser diodes within the apparatus 100 and slow scan (or raster) speeds of the corresponding energy beams over the build platform 112.

### 6. Processor and Sensors

One variation of the apparatus 100 includes a processor 190 configured to selectively power discrete laser diodes in the set of discrete laser diodes according to the position of the first laser output optic 141 and the first laser output optic 141. In particular, the processor 190 can implement the first method and/or the second method described below to intermittently power one or more discrete laser diodes as various power (or energy) densities to selectively preheat, fuse, and/or anneal particular areas of each layer of dispensed powdered material. For example, the processor 190 can step through lines of machine tool program (e.g., in G-code) loaded into the apparatus 100, and, for each X-Y coordinate specified in the machine tool program, the processor 190 can trigger a first laser diode 171 to generate a first energy beam of sufficient power to locally melt powdered material in a topmost layer at a sufficient depth to fuse with fused powders in an adjacent layer below as the first, second, and/or third actuators scan a first laser output optic over the build platform 112. In this example, as the first laser output optic 141 is rastered over the build platform 112, the processor 190 can further implement look-ahead techniques to trigger a second laser diode 172 to generate a second energy beam of sufficient power to locally preheat powdered material in the topmost layer when an upcoming X-Y coordinate specified in the machine tool program matches a current projection coordinate for a second laser output optic (or lens) corresponding to the second laser diode 172. Similarly, in this example, as the first and second laser output optics are rastered over the build platform 112, the processor 190 can implement look-behind techniques to trigger yet a third laser diode to generate a third energy beam of sufficient power to locally anneal melted material in the topmost layer when an recent X-Y coordinate specified in the machine tool program matches a current projection coordinate for a third laser output optic (or lens) corresponding to the third laser diode. As described below, as in this example, the processor 190 can similarly control the outputs of multiple discrete laser diodes to simultaneously and selectively generate energy beams of sufficient power to preheat, melt, and/or anneal local areas of a topmost layer of powdered material. Furthermore, once a series of X-Y coordinates corresponding to one Z-position in the machine tool program is completed, the processor 190 can trigger Z-axis actuator 154 to lower the build platform 112 by a specified amount, trigger the material dispenser 120 to dispense a fresh layer of powdered material over the previous layer of powdered material, and then control the positions of and/or output from various laser output optics according to a subsequent series of X and Y coordinates corresponding to latest Z-position of the build platform 112. Thus, in this variation, as a laser output optic moves over various regions of a layer of powdered material below, a controller within the apparatus 100 (i.e., the processor 190) can intermittently power a select laser diodes to project one or more energy (i.e., laser) beams onto select regions of the layer, thereby heating, melting, and/or annealing only these select regions of particular layers of dispensed powdered material.

In this variation, the processor 190 can further adjust a power, operating wavelength, pulse time, and/or other parameter of one or more laser diodes within the apparatus 100 based on a detected temperature of a region of a topmost layer of deposited material. For example, in this variation, the apparatus 100 can further include an image sensor arranged within the build chamber 110 and configured to output a digital image of a laser sintering site over the build platform 112. In this example, the processor 190 can control a shutter speed of the image sensor, correlate a light intensity of a pixel within the digital image with a temperature at the laser sintering site, and regulate a power output of the first laser diode 171 based on the temperature at the laser sintering site, as described in U.S. patent application Ser. No. ______. The processor 190 can also correlate light intensities of multiple other pixels or sets of pixels within the digital image with various temperature and/or a temperature gradient across a corresponding area of the layer of powdered material (including the laser sintering site) and regulate one or more operating parameters of multiple laser diodes simultaneously and accordingly. Generally, in this variation, the processor 190 can control a power output or other operating parameter of a laser diode to yield a suitable temperature at a corresponding laser interaction zone such that the powdered material reaches a target temperature (±a tolerance) or a target temperature range, such as within a unit time that the energy beam is incident on the corresponding laser interaction zone. For example, the processor 190 can control multiple laser diodes independently to simultaneously adjust a power density of a first energy beam to achieve a target preheat temperature, a power density of a second energy beam to achieve a target melt temperature, and a power density of a third energy beam to achieve a target anneal temperature (or target heat transfer rate out of an annealing zone). In this example, the processor 190 can retrieve a target preheat temperature, a target fuse temperature, and/or a target anneal temperature (or target rate of temperature change) from a material supply cartridge supplying powdered material to the build chamber 110, such as described above, and the processor 190 can adjust a pulse time or other operating parameter of corresponding laser diodes accordingly. However, the processor 190 can interface with any other component within the apparatus 100 to detect a temperature at any other point or area across the dispensed powdered material, and the processor 190 can control any laser diode or other component within the apparatus 100 accordingly in any other suitable way.

### 2. Method and Applications

As shown in FIG. 7, a method for fusing and annealing powdered material within an apparatus for manufacturing, the method including: depositing a layer of powdered material across a build platform in Block S102; at a first time, projecting a first energy beam of a first power density onto an area of the layer of powdered material in Block S110; and at a second time succeeding the first time, projecting a second energy beam of a second power density less than the first power density onto the area in Block S120.

As shown in FIG. 8, one variation of the method includes: depositing a layer of powdered material across a build platform in Block S102; projecting a first energy beam along a first direction across the layer of powdered material in Block S110, the first energy beam of a first power density at the layer of powdered material; projecting a second energy beam across the layer of powdered material in Block S120, the second energy beam trailing the first energy beam and of a second power density at the layer of powdered material less than the first power density; and projecting a third energy beam across the layer of powdered material in Block S130, the third energy beam preceding the first energy beam and of a third power density at the layer of powdered material less than the first power density.

Generally, the method can be executed by the apparatus 100 described above to selectively preheat, melt (or “fuse”), and then anneal (i.e., stress-relieve) select volumes of powdered material dispensed in layers over a build platform within the apparatus 100. By fusing and subsequently annealing local volumes of powdered material as a part is constructed via selective laser sintering (SLS) techniques within a single part build cycle, residual stresses common to SLS parts can be substantially reduced, thereby eliminating a need to a subsequent stress-relieving process after the additive manufacturing of the part is completed within the apparatus 100. In particular, as a part is additively constructed within the apparatus 100 by selectively projecting an energy (e.g., laser) beam onto particular areas of subsequent layer of powdered material, residual stresses are created within fused volumes as melted material within these volumes cools. However, before a subsequent layer of powdered material is dispensed over a current layer of material with selectively-fused volumes, a second energy beam is projected onto these volumes of fused material to cycle these fused volumes through a stress-relieving procedure, thereby locally reducing residual stresses. The method repeats these procedures for fused volumes in each subsequent layer of powdered material to locally stress-relieve “small” volumes of fused material such that, when a part build cycle completes, the entire volume of the manufactured part has undergone a stress-relieving procedure on a local (e.g., small-volume) scale.

### 2.1 Depositing Material

Block S102 of the method recites depositing a layer of powdered material across a build platform. Generally, Block S102 functions to transfer powdered material from a material cartridge described above (or other material supply) into the build chamber 110 as a series of layers of powdered material dispensed and leveled sequentially. Block S102 can thus interface with the material dispenser 120 and a Z-axis actuator 154 coupled to the build platform 112—as described above—to dispense and level layers of powdered material of substantially constant (or controlled) thickness first over the build platform 112 and then over previous layer of powdered material. For example, Block S102 can deposit sequential layers of powdered material, each approximately 100 nanometers in thickness. In this example, Block S110 can project an energy beam of sufficient power density to fully melt powdered material at a depth of 100% of the full thickness of the current layer for areas of the current layer not arranged over fused volumes of the preceding layer, and Block S110 can project an energy beam of sufficient power density to fully melt powdered material at a depth of 200-400% of the full thickness of the current layer for areas of the current layer arranged over fused volumes of the preceding layer such that adjacent volumes of fused material in the current and preceding layers melt together into a single volume. In this example, Blocks S110 and S120 can thus control a power density (or other property) of the first and second energy beams, respectively, according to the thickness of a current layer of material dispensed into the build chamber 110 in Block S102.

However, Block S102 can function in any other way to deposit a series of layers of powdered material over the build platform 112 within the build chamber 110.

### 2.2 Melting and Annealing Powdered Material

Block S110 of the method recites, at a first time, projecting a first energy beam of a first power density onto an area of the layer of powdered material. Block S110 can similarly recite projecting a first energy beam along a first direction across the layer of powdered material, the first energy beam of a first power density at the layer of powdered material. Block S120 of the method recites, at a second time succeeding the first time, projecting a second energy beam of a second power density less than the first power density onto the area. Block S120 can similarly recite projecting a second energy beam across the layer of powdered material, the second energy beam trailing the first energy beam and of a second power density at the layer of powdered material less than the first power density.

Generally, Blocks S110 and S120 functions to serially project energy beams onto a select area of a layer of powdered material in series to first fuse and to then anneal material in the select area, respectively. Block S110 can control a first discrete laser diode within the apparatus 100 to selectively (e.g., intermittently) output a first energy beam based on a position of the first laser output optic 141 (and/or positions of the first and second actuators in either of the scan mirror and gantry configurations), a position of the build platform 112, and a digital build file specifying a three-dimensional geometry of a part under construction such that the first energy beam is projected onto select areas of each layer of powdered material. In particular, when the first energy beam is projected onto a select area of the layer of powdered material, a volume of powdered material—within the topmost layer and under the incident area of the energy beam on the surface of the layer—melts, thus fusing powders within this volume together (and thus fusing this volume to an adjacent volume of fused powder below). This volume of fused powder—like other volumes of powders fused within the build chamber 110 during a part build cycle—corresponds to a particular volume of a part under construction within the build chamber 110 as prescribed in the digital build file. This process (i.e., Block S110) repeats for select areas of each layer of powdered material such that—upon completion of the part build cycle—the full volumetric geometry of the part is constructed of fused powders. The completed part can then be removed from the build chamber 110, the build chamber 110 evacuated of the remaining powdered material, and a build cycle initiated once again to create another part.

Furthermore, Block S120 can control a second discrete laser diode within the apparatus 100 to selectively output a second energy beam—similarly based on a position of the second laser output optic 142, the position of the build platform 112, and the digital build file—to heat previously-melted volumes of layers of material dispensed over the build platform 112. In particular, Block S120 projects a second energy beam onto a volume of material recently melted by the first energy beam to prolong a cooling period of the volume of material. By dispensing energy into the volume of material with an incident energy beam after powdered material within the volume is melted, temperatures within the volume of melted material can be made more uniform, thereby reducing local residual stresses within the volume of melted material and between the volume and an adjacent volume of melted material as the volume(s) cool. Thus, in this implementation, Block S120 can project the second energy beam onto an area of a layer of powdered material substantially immediately after the corresponding volume of powdered material is melted such that the second energy beams controls the cooling cycle (e.g., transition from the liquid phase to the solid phase) of the volume of melted material.

Alternatively, once a particular volume of material melted by the first energy beam cools (e.g., to within 15% of an operating temperature within the build chamber 110), Block S120 can project the second energy beam onto a corresponding area of the layer to reheat the particular volume of material to a particular temperature below a melting temperature of the material, to hold the particular volume of material at the particular temperature, and to then control cooling of the material back to the operating temperature within the build chamber 110. For example, Block S120 can project a single (second) energy beam toward a particular area of the layer of powdered material corresponding to a previously-melted volume of material, the single energy beam focus over a substantially large area (e.g., larger than a focus area of the first energy beam) over the layer with the a non-uniform power density across the area. In this example, Block S120 can focus the single energy beam of a Gaussian distribution onto the layer such that, as the single energy beam is scanned linearly across the particular area of the layer, the leading edge of the single energy beam begins to raise the temperature of the corresponding volume of material. The power density of the beam incident on the layer increases up to a peak power density as the single energy beam is scanned forward. The volume of material thus reaches a maximum temperature before beginning a cooling cycle as the trailing edge of the single energy beam approaches and then passes over the area of the layer. In this example, Block S120 can hold the power density of the second (i.e., single) energy beam substantially constant and at a level sufficient to heat and then cool—but not re-melt—a volume of previously-melted material in a controlled fashion, such as for a constant scanning speed of the second energy beam across the layer. Block S120 can also modulate (e.g., increase and/or decrease) the power density, power distribution, and/or scanning speed of the second energy beam as the second energy beam is scanned over a particular area of the layer to achieve a target stress-relieving schedule (e.g., temperate increase, temperature hold, and temperature decrease over a period of time) for the particular volume of powdered material.

Yet alternatively, Block S120 can control multiple energy beams projected onto overlapping or disjoint spots on the topmost layer of powdered material to anneal (or stress-relieve) a melted volume of material within the build chamber 110. For example, Block S120 can project a set of six energy beams onto a corresponding set of linearly-spaced, adjacent and disjoint round spots on the surface of the topmost layer of powdered material. In this example, Block S120 sets energy beams in the set at different power densities such that the first two energy beams incident in sequence on a particular area of the layer—corresponding to a previously-melted and then cooling volume of material—heat the volume of material up to a target stress-relieving temperature, the second and third energy beams incident on the volume of material in series maintain the volume of material substantially near the target stress-relieving temperature, and the fifth and sixth energy beams incident on the volume of material in series extend a cooling period of the volume of material as the volume of material returns to an operating temperature within the build chamber 110 (e.g., an environmental temperature within the build chamber 110 during a part build cycle).

Block S120 can also project a set of energy beams incident onto the topmost layer of powdered material in a square array, a close-pack array, a line, or any other suitable pattern of overlapping or disjoint spots to anneal a volume of powdered material previously melted (or fused) in Block S110 during a part build cycle. Block S110 can similarly project multiple energy beams substantially simultaneously onto a topmost layer of powdered material to melt one or more discrete volumes of material at any given instant during a part build cycle.

### 2.3 (Substantially) Simultaneous Projection of Energy Beams

In one implementation, Block S110 includes generating the first energy beam at a first laser diode 171, focusing the first energy beam onto the layer of powdered material, and displacing the first energy beam across the layer of powdered material along a first direction. In this implementation, Block S110 can include generating the second energy beam at a second laser diode 172 substantially simultaneously with the first energy beam, focusing the second energy beam onto the layer of powdered material adjacent the first energy beam, and displacing the second energy beam along the first direction behind the first energy beam. For example, in the scan mirror configuration described above, a first discrete laser diode and a second discrete laser diode can be independently controlled to generate the first energy beam and the second energy beam, respectively, and the first and second energy beams can be projected simultaneously onto a rotating mirror, then onto a lens, and finally onto discrete areas of the topmost layer of powdered material. As the first actuator 151, the second actuator 152, the mirror, and the lens 160 cooperate to scan the discrete energy beams across the layer of powdered material, the second energy follows the first energy beam at a substantially constant offset with the first energy beam at a power density sufficient to locally melt powdered material on the topmost layer over the build platform 112, the second energy beam at a lower density sufficient to prolong local cooling of recently-melted material, thus stress-relieving the recently-melted material.

Furthermore, in one variation of this implementation shown in FIG. 8, the method includes Block S130, which recites generating a third energy beam at a third laser diode substantially simultaneously with the first energy beam, focusing the third energy beam onto the layer of powdered material adjacent the first energy beam, and displacing the third energy beam along the first direction ahead of the first energy beam, the third energy beam of a power density less than the first power density. Block S130 can similarly recite projecting a third energy beam across the layer of powdered material, the third energy beam preceding the first energy beam and of a third power density at the layer of powdered material less than the first power density.

In particular, in this variation, Block S130 can generate the third energy beam of a power density insufficient to melt the powdered material (at a displacement rate of the third energy beam over the build platform 112) but sufficient to locally heat (i.e., preheat) areas of the topmost layer of the powdered material prior to melting by the first energy beam. For example, the first actuator 151, the second actuator 152, the mirror, and the lens 160 can cooperate to scan the third energy beam across the layer of powdered material with the first and second energy beams, the third energy beam preceding the first energy beam by a fixed offset, and the first energy beam preceding the second energy beam by a (similar) fixed offset such that a particular area of the topmost layer of powdered material is preheated, melted (or “fused”), and then annealed as the third energy beam, then the first energy beam, and then the second energy beam, respectively, are serially projected onto the particular area. In this example, each of a first laser diode 171, a second laser diode 172, and a third laser diode can be coupled to a first laser output optic, a second laser output optic, and a third laser output optic, respectively, and the laser output optics can be arranged in fixed positions relative to one another to project the first, second, and third energy beams in a preset pattern (e.g., a close-pack array) toward the mirror 130 such that the mirror 130 reflects the energy beams onto the lens 160 and the lens 160 focuses the energy beams onto the layer of powdered material below in a substantially constant corresponding pattern.

Thus, as in foregoing variation, Block S130 can include selectively preheating areas of the layer of powdered material with the third energy beam, Block S110 can include selectively fusing areas of the layer of powdered material with the first energy beam, and Block S120 can include selectively annealing areas of the layer of powdered material with the second energy beam. In particular, as in the foregoing implementation, Block S110, S120, and/or S130, etc. can be implemented through the first actuator 151, the second actuator 152, the mirror, and the lens 160, etc. in a scan mirror configuration described above to substantially simultaneously focus multiple energy beams onto the topmost layer of powdered material on the build platform 112. For example, at a first time, Block S110 can control elements within the apparatus 100 to project the first energy beam onto a first area of the layer of powdered material to melt material within the first area, Block S120 can control elements within the apparatus 100 to project the second energy beam onto a second area of the layer of powdered material (behind the first area relative to a traverse direction of the beams across the build platform 112) to anneal material within the second area, and Block S130 can control elements within the apparatus 100 to project the third energy beam onto a third area of the layer of powdered material ahead of the first area to preheat material within the third area. In this example, the first and/or second actuators can move the mirror 130 and/or the laser head forward such that, at a second time following the first time, the first energy beam is projected onto a third area of the layer of powdered material to melt preheated material within the third area, the second energy beam is projected onto the first area of the layer of powdered material to anneal melted material within the first area, and the third energy beam is projected onto a fourth area of the layer of powdered material ahead of the third area to preheat material within the fourth area.

Alternatively, Blocks S110, S120, and/or S130, etc. can be similarly implemented through the first actuator 151, the second actuator 152, one or more laser diodes, and a set of laser output optics coupled to the first and second actuators in a gantry configuration described above to substantially simultaneously focus multiple energy beams onto the topmost layer of powdered material. For example, Block S110 can include focusing a first discrete laser beam through a first laser output optic, Block S120 can include focusing a second discrete laser beam through a second laser output optic, and Block S130 can include focusing a third discrete laser beam through a third laser output optic ganged with the first laser output optic 141 and the second laser output optic 142, and the first and second actuators can cooperate to scan the laser output optics over the build platform 112. Then as in this and other configurations, a processor 190 within the apparatus 100 can control execution of Blocks of the method by intermittently powering laser diodes within the apparatus 100—such as based on a position of the mirrors, the laser head, the first or second actuators, etc. and the geometry of the part under construction within the apparatus 100 as specified in a digital build file)—to intermittently output corresponding energy beams onto the topmost layer of powdered material over the build platform 112, thereby preheating, melting, and/or annealing select sub-volumes of the total volume of powdered material dispensed into the build chamber 110, one layer of powdered material at a time. Thus, energy beams of various power (or energy) densities can be projected toward the build platform 112 substantially simultaneously with energy beams of different power densities colliding with a particular sub-area on the topmost layer of powdered material serially as the energy beams are scanned over the build platform 112.

As described above, the method can include projecting multiple energy beams toward the build platform 112 substantially simultaneously. For example, in addition to projecting the first energy beam, the second energy beam, and/or the third energy beam toward the build platform 112 in Blocks S110, S120, and S130, respectively, the method can also include Block S140, which recites projecting a fourth energy beam toward the layer of powdered material, and Block S151, which recites projecting a fifth energy beam toward the layer of powdered material. Thus, in this example, Blocks S110, S120, S130, S140, and S151, etc. can cooperate to focus the first energy beam, the second energy beam, the third energy beam, the fourth energy beam, and the fifth energy beam onto a square array of spots onto the layer of powder material.

In one implementation, the apparatus 100 executing the method includes multiple laser diodes, and Blocks S110, S120, S130, etc. project multiple corresponding energy beams substantially simultaneously onto the topmost layer of powdered material. In this implementation, Block S130 can include projecting of a third subset of the energy beams at a third power density level toward the build platform 112 to heat (but not melt) the topmost layer of powdered material, Block S110 can include projecting a first subset of the energy beams at a first power density level toward the build platform 112 to melt the powdered material, and Block S120 can include projecting a second subset of the energy beams toward the build platform 112 at a second power density level to anneal (by heating at low temperature) recently melted material, such as shown in FIG. 9.

In the foregoing implementation, Block S120 can also control one or more laser diodes in the apparatus 100 to generate energy beams in the second subset of energy beams at a variety of power (or energy) densities. For example, Block S120 can generate multiple discrete energy beams—in the second subset of energy beams—with power densities decreasing (e.g., linearly) with offset distance from the first energy beam, as shown in FIG. 10. In this example, as the set of energy beams traverses the surface of the topmost layer of powdered material and once the first energy beam melts a particular area of the layer of powdered material, the sequence of lower-power-density energy beams in the second subset of energy beams controls local cooling (i.e., annealing) across the particular area over a period of time (corresponding to a traverse speed of the energy beams). Thus, in this example, the method can include Block S132, which recites generating a fourth energy beam at a fourth laser diode substantially simultaneously with the first energy beam, focusing the fourth energy beam onto the layer of powdered material adjacent the second energy beam, and displacing the fourth energy beam along the direction behind the second energy beam, the fourth energy beam of a power density less than the second power density.

Blocks S110, S120, and/or S130, etc. can also cooperate to modulate the power densities (or energy densities or other properties) of the various energy beams (substantially) simultaneously projected toward the build platform 112 as the energy beams are scanned thereacross. In one example, Blocks S110, S120, and/or S130, etc. control laser diodes within the apparatus 100 to scan the first, second, and/or third energy beams, respectively, in a continuous boustrophedonic path over the build platform 112 and cooperate to adjust the function of the energy beams (e.g., for preheating, for melting, or for annealing) according to the direction of travel of the energy. In particular, in this example, Blocks S110 and S120 can control various elements within the apparatus 100 to displace the first energy beam and the second energy beam across the layer of powdered material along a first direction during a first period of time (including the first time and the second time). Subsequently, Blocks S110 and S120 can control various elements within the apparatus 100 to displace the first energy beam and the second energy beam across the layer of powdered material along a second direction during a second period of time succeeding the first period of time, wherein the second direction is opposite the first direction, and wherein the second energy beam is of a power density at the layer of powdered material greater than a power density of the first beam at the layer of powdered material during the second period of time, as shown in FIG. 11. Specifically, as in this example, Blocks S110, S120, and/or S130, etc. can cooperate to modulate the power densities or other properties of the outputs of various laser diodes within the machine to serially preheat, melt, and then anneal particular areas of the topmost layer of powdered material with a series of energy beams even as the scanning direction of the energy beams changes throughout a part build cycle.

Furthermore, in the gantry configuration, when the first actuator 151 reaches a workspace travel limit when moving the laser output optics along a first direction, the method can trigger the second actuator 152 to index the laser output optics in a second direction perpendicular to the first direction, and the first actuator 151 can again move along (or opposite) the first direction to scan the energy beams along an adjacent linear area of the topmost layer of powdered material. Similarly, in the scan mirror configuration, when an arcuate position of the mirror 130 reaches a maximum threshold angle to the build platform 112, the method can trigger the first actuator 151 to index the laser output optics in a second direction perpendicular to the scan direction of the energy beams toward the build platform 112, and the second actuator 152 can rotate the mirror 130 such that a subsequent facet of the mirror 130 comes into view of the laser output optics to again scan the energy beams along an adjacent linear area of the lens 160 and then onto an adjacent linear area of the topmost layer of powdered material

### 2.4 Energy Beam Patterns and Properties

As described above and shown in FIG. 9 and 10, Blocks of the method can project multiple energy beams substantially simultaneously toward the build platform 112. Block S110, S120, and/or S130, etc. can project the first, second, and/or third energy beams, etc., respectively onto disjoint (i.e., non-intersecting) or overlapping spots (i.e., areas) on the surface of a topmost layer of powdered material over the build platform 112. Block S110 can also project multiple energy beams in a particular and at one or more power densities to melt select areas of each layer of powdered material; Blocks S120 and S130, etc. can similarly project sets of energy beams toward the build platform 112 to anneal and preheat, respectively, select areas of each layer of powdered material.

In one implementation, Block S110 focuses the first energy beam onto a first spot coincident with a particular area of the layer of powdered material, and Block S120 focuses the second energy beam onto a second spot coincident with the area of the layer of powdered material, wherein the first spot is bounded by the second spot. For example, Block S120 can focus the second energy beam over a second spot of a relatively large area on the surface of the topmost layer of powdered material, and Block S110 can project the first energy beam onto a first spot of a smaller area on the surface of the layer, the first spot near the leading edge of the second spot as the first and second spots are scanned in one direction over the layer, as shown in FIG. 12A. In this example, the first energy beam is of an power energy density sufficient to melt the powdered material, and the second energy beam is of an energy or power density sufficient to stress-relieve but not re-melt a volume of the layer previously melted by the first energy beam such that the first spot melts powdered material locally and the area of the second spot trailing the first spot anneals the melted material immediately thereafter. Thus, the first and second energy beams can be of similar total powers but corresponding spots (i.e., interaction zones) at the surface of a layer of powdered material can be (significantly) greater for the first energy beam that is focused on a smaller area than the second energy beam. In a similar example, the first spot is projected near a center of the second spot such that a leading area of the second spot (ahead of the first spot) preheats incident areas of the topmost layer of powdered material, the first spot fuses local volumes of the layer of powdered material, and a trailing region of the second spot (behind the first spot) anneals volumes of material previously fused by the first spot, as shown in FIG. 12B.

In yet another example, Blocks S110 and S120 can cooperate to displace the first spot relative to the second spot as the first and second energy beams are scanned over the build platform 112 and focused onto a topmost layer of powdered material below. In this example, Block S110 can project the first energy beam onto the first spot with its effective center at a first distance from an effective center of the second spot at one time, and Block S110 can project the first energy beam onto the first spot with its effective center at a second distance from the effective center of the second spot at a later time, wherein the first distance is greater than the second distance. In particular, in this example, Blocks S110 and S120 can move the first spot relative to the second spot based on a scanning speed of the first and second energy beams, such as by moving the first spot closer to a leading edge of the second spot for faster scanning speeds and moving the first spot closer to a center of the second spot for slower scanning speeds. Blocks S110 and S120 can additionally or alternatively move the first spot relative to the second spot based on a scanning direction of the first and second energy beams, such as by maintaining the first spot near a leading edge of the second spot regardless even as the scanning direction of the energy beams changes (e.g., for direction changes over a boustrophedonic scan path). In this example, Blocks S110 and/or S120 can manipulate focusing systems and/or actuators coupled to lens output optics to shift the position of the energy beam relative to one another. Blocks S130, and/or S140, etc. can implement similar functionality to manipulate the positions of corresponding energy beams relative to the first and/or second energy beams projected toward the build platform 112.

In the foregoing implementation, Block S110 can control a corresponding laser diode to generate the first beam of a first wavelength, and Block S120 can control a corresponding laser diode to generate the second beam of a second wavelength different than the first wavelength. In particular, Blocks S110 can S120 can cooperate to project overlapping (or intersecting) energy beams of different wavelengths to control (or minimize) constructive and destructive interference between the first and second energy beams. In the variation of the method that includes Block S130, Block S130 can similarly control a corresponding laser diode to generate the third beam of a third wavelength, different than the first and second wavelengths.

Blocks of the method can also interface with various elements within the apparatus 100 to project energy beams of particular shapes and/or power distributions toward the build platform 112. For example, Block S110 can include generating the first energy beam exhibiting a Gaussian power distribution (i.e., a “Gaussian beam”) and collimating the first energy beam by passing the first energy beam through a flattop refractive beam shaper. In particular, the beam shaper can convert the Gaussian beam into a flattop energy beam exhibiting a substantially square power distribution over its cross-section. Block S110 can additionally or alternatively pass the first energy beam through the beam shaper that transforms a circular energy beam into a square or rectilinear energy beam, and Block S110 can thus project multiple square or rectilinear energy beams in a tight square array. In particular, the apparatus 100 can include substantially low-power (e.g., ½-Watt to 2-Watt) laser diodes, which each generate a low-power energy beam that is passed through a corresponding beam shaper and then projected onto the topmost layer of powdered material in as a square array of square-shaped flattop energy beams, thus yielding a rectilinear spot of substantially uniform power distribution and sufficient power to melt a volume of powdered material over a large area of the topmost layer in Block S110—despite application of relatively low-power laser diodes in the apparatus 100. Block S120, S130, etc. can interface with similar elements of the apparatus 100 to project similar arrays of energy beams toward the build platform 112. These Blocks can also project arrays of energy beams of different power densities in constant or dynamic patterns toward the build platform 112, such as shown in FIGS. 9 and 10.

However, Blocks of the method can interface with one or more laser diodes to control any other parameter of a corresponding energy beam projected toward the build platform 112 to preheat, melt, or anneal a volume of powdered material within the build chamber 110.

### 2.5 Serial Projection of Energy Beams

As described above, Blocks S110 and S120 can cooperate to project the first and second energy substantially simultaneously toward the build platform 112. In particular, Blocks S110 and S120 can project the first and second energy beams onto a layer of powdered material during a single scan path over the layer. Alternatively, Blocks S110 and S120 can project the first and second energy beams toward the build platform 112 serially. In particular, Block S110 can project the first energy beam onto a layer of powdered material during a first scan path over the layer, and Block S120 can project the second energy beam onto the layer during a second scan path over the layer once the first scan path is completed. For example, Block S110 can include scanning the first energy beam across the layer of powdered material during a first period of time (including the first time), and can Block S120 can include scanning the second energy beam across the layer of powdered material during a second period of time (including the second time and succeeding the first period of time).

In this implementation in which Block S110 and S120 project the first and second energy beams toward the build platform 112 serially, Blocks S110 and S120 can also control the first and/or second actuators to scan corresponding energy beams over the build platform 112 at different speeds. For example, Block S110 can displace the first energy beam linearly across an area of the layer at a first speed to fuse powdered material within the area, and Block S120 can displace the second energy beam linearly across the area at a second speed less than the first speed to anneal fused material within the area. Thus, Block S120 can project the second energy beam as a slower speed and at a lower power density than the first energy beam to controllably heat a volume of material up to a target stress-relieving temperature, to maintain the volume of material substantially near the target stress-relieving temperature, and to control a cooling period of the volume of material as the volume of material returns to an operating temperature within the build chamber 110.

In this implementation, Block S110, S120, and/or S130, etc. can implement similar functionality as that described above to project one or more energy beams of any particular wavelength(s) or parameter(s) onto the surface of a topmost layer of powdered material in any suitable pattern.

### 2.6 Temperature Feedback

Blocks S110, S120, and/or S130, etc. can further implement closed loop feedback to adjust a size, shape, total power, power density, and/or other parameter of a corresponding energy beam projected toward the build platform 112 based on a detected temperature of powdered material within the build chamber 110.

In one implementation, Block S110 implements methods and techniques described in U.S. patent application Ser. No. 14/212,875 to detect a temperature, a peak temperature, and/or a temperature gradient at a surface of the topmost layer of powdered material deposited over the build platform 112. In this implementation, Block S110 can also retrieve melting temperature parameters for the particular type of powdered material—such as from the material cartridge as described above—insert this temperature parameter and the detected peak temperature at a laser sintering site on the layer of material into a proportional-integral-derivative controller, and adjust the power of the first laser diode 171 according. In particular, Block S110 can increases the power output of the first laser diode 171 if the detected peak temperature at the laser sintering site is below a peak temperature specified in the temperature parameter, and Block S110 can decreases the power output of the first laser diode 171 if the detected peak temperature at the laser sintering site is above a peak temperature specified in the temperature parameter. Blocks S130 and S120 implement similar functionality to achieve a target preheat temperature and to achieve a target cooling schedule (i.e., target temperatures over a period of time), respectively. However, Block S110, S120, and/or S130 can implement temperature feedback to control the power or other parameter of corresponding energy beams incident on a topmost layer of powdered material within the build chamber 110 during a part build cycle.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of an apparatus, laser sintering device, user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. An apparatus for manufacturing, comprising:
a build chamber comprising a build platform;
a material dispenser configured to distribute a layer of powdered material over the build platform;
a mirror arranged over the build platform, defining a mirrored planar surface, and isolated from an environment within the build chamber!;
a first laser output optic configured to output a first energy beam toward the mirror;
a second laser output optic adjacent the first laser output optic and configured to output a second energy beam toward the mirror;
a first actuator configured to maneuver the first laser output optic and the second laser output optic relative to the build platform;
a lens arranged between the mirror and the build platform; and
a second actuator configured to maneuver the mirror to scan the first energy beam and the second energy beam across the lens, the lens outputting the first energy beam and the second energy beam toward and substantially normal to the build platform.

2. The apparatus of claim 1, further comprising a set of discrete laser diodes, each laser diode in the set of laser diodes configured to generate a discrete energy beam and coupled by a fiber optic cable to a laser output optic in a set of laser output optics, the set of laser output optics configured to output discrete energy beams toward the mirror, the first actuator configured to translate the set of laser output optics with the first laser output optic and the second laser output optic relative to the build platform, and the lens outputting discrete energy beams from the set of discrete laser diodes toward and substantially normal to the build platform.

3. The apparatus of claim 2, wherein each laser diode in the set of laser diodes is configured to output a discrete Gaussian beam, wherein the lens outputs discrete Gaussian beams from the set of laser diodes in a close-packed array proximal a surface of the layer of powdered material.

4. The apparatus of claim 2, further comprising a processor configured to selectively power discrete laser diodes in the set of discrete laser diodes according to a position of the mirror, a position of the first laser output optic, and a height of the a layer of powdered material over the build platform.

5. The apparatus of claim 1, further comprising a first discrete laser diode configured to output the first energy beam at a first wavelength and coupled to the first laser output optic by a first fiber optic cable, further comprising a second discrete laser diode configured to output the second energy beam at a second wavelength different than the first wavelength and coupled to the second laser output optic by a second fiber optic cable, the first laser output optic comprising a refractive beam shaper configured to collimate the first energy beam and to output the first energy beam adjacent and substantially parallel to the second energy beam.

6. The apparatus of claim 5, wherein the first laser diode generates the first energy beam of a first power density, and wherein the second laser diode generates the second energy beam of a second power density less than the first power density.

7. The apparatus of claim 1, wherein the lens is configured to focus the first energy beam and the second energy beam across a plane coincident with the layer of powdered material.

8. The apparatus of claim 7, wherein the lens is configured to focus the first energy beam at a first spot over the layer of powdered material and to focus the second energy beam at a second spot over the layer of powdered material, the first spot within a boundary of the second spot and of a power density greater than a power density of the second spot.

9. The apparatus of claim 1, wherein the lens comprises an F-theta scan lens, and further comprising a housing cooperating with the lens to enclose the first laser output optic, the second laser output optic, and the mirror, and wherein the first actuator is configured to displace the housing linearly across the build platform.

10. The apparatus of claim 9, further comprising a bar diode coupled to the first laser output optic by a first elastic fiber optic cable passing through the housing and coupled to the second laser output optic by a second fiber optic cable passing through the housing.

11. The apparatus of claim 1, wherein the build chamber comprises a ceiling arranged over the build platform and isolating the mirror from airborne particulate within the build chamber, and wherein the lens comprises an F-theta lens passing through the ceiling.

12. The apparatus of claim 1, wherein the mirror comprises a polygonal cylinder defining a set of planar mirrored surfaces, wherein the first actuator is configured to displace the first laser output optic and the second laser output optic along an path parallel to a central axis of the polygonal cylinder, and wherein the second actuator is configured rotate the mirror about the central axis of the polygonal cylinder.

13. The apparatus of claim 1, further comprising a first laser diode coupled to the first laser output optic and configured to generate the first energy beam, further comprising an image sensor arranged within the build chamber and configured to output a digital image of a laser sintering site over the build platform, and further comprising a processor configured to control a shutter speed of the image sensor, to correlate a light intensity of a pixel within the digital image with a temperature at the laser sintering site, and to regulate a power output of the first laser diode based on the temperature at the laser sintering site.

14. The apparatus of claim 13, wherein the processor is configured to retrieve a target fuse temperature from a material supply cartridge supplying powdered material to the build chamber, the processor further configured to regulate the power output of the first laser diode based on the target fuse temperature of the powdered material.

15. The apparatus of claim 13, wherein the processor is configured to adjust a pulse time of the first laser diode.

16. An apparatus for manufacturing, comprising:
a build chamber comprising a build platform;
a material dispenser configured to distribute a layer of powdered material over the build platform;
a first laser output optic configured to output a first energy beam toward the build platform and substantially normal to the layer of powdered material;
a second laser output optic adjacent the first laser output optic and configured to output a second energy beam substantially parallel to and offset from the first energy beam;
a first actuator configured to maneuver the first laser output optic and the second laser output optic along a first axis parallel to the layer of powdered material; and
a second actuator configured to maneuver the first laser output optic and the second laser output optic along a second axis parallel to the layer of powdered material and perpendicular to the first axis.

17. The apparatus of claim 16, wherein the first laser output optic comprises a first laser diode configured to output the first energy beam at a first wavelength between 360 nanometers and 480 nanometers, and wherein the second laser output optic comprises a second laser diode configured to output the second energy beam at a second wavelength different than the first wavelength.

18. The apparatus of claim 16, wherein the first laser output optic and the second laser output optic are suspended from a gantry, and wherein the first actuator and the second actuator cooperate to scan the gantry over the build platform.

19. The apparatus of claim 18, further comprising a third laser output optic suspended from the gantry, the third laser output optic configured to output a third energy beam substantially normal to the layer of powdered material and offset from the first energy beam and the second energy beam in a staggered configuration.

20. The apparatus of claim 16, further comprising a first discrete laser diode configured to generate the first energy beam and a second discrete laser diode configured to generate the second energy beam, the first discrete laser diode and the second discrete laser diode coupled to the first discrete laser diode and the second discrete laser diode by a multi-cored fiber.
